(19) United States
(12) Patent Application Publication
(10) Pub. No.: US 2016/0006657 A1
(43) Pub. Date: Jan. 7, 2016

(54) ETHERNET VIRTUALISATION INTERCONNECTION NETWORKS HAVING A HUB-SPOKE STRUCTURE

(71) Applicant: HANGZHOU H3C TECHNOLOGIES CO. LTD., Hangzhou, Zhejiang (CN)

(72) Inventors: Xiaoheng SONG, Beijing (CN); Xia QIN, Beijing (CN)

(21) Appl. No.: 14/768,730

(22) PCT Filed: Jan. 15, 2014
(86) PCT No.: PCT/CN2014/070685

§ 371 Date: Aug. 18, 2015

(30) Foreign Application Priority Data
Feb. 25, 2013 (CN) 201310058202.7

(51) Int. Cl. H04L 12/741; H04L 12/18; H04L 12/44; H04L 12/46; H04L 12/713

(52) U.S. Cl. CPC H04L 45/745; H04L 12/4641; H04L 45/586; H04L 12/44; H04L 12/18; H04L 2012/445

(57) ABSTRACT

The present disclosure describes an example of device for use in an Ethernet Virtualisation Interconnection (EVI) network having a Hub-Spoke structure. The EVI network comprises a first Hub Edge Device (Hub-ED) and a second Hub-ED, the device comprising a memory unit to store instructions; and a processor to perform the instructions from the memory unit. The processor receives a message having an identifier, the identifier identifying a destination address of the message. The processor selects an EVI link interface from a set of EVI link interfaces having a first EVI link interface and a second EVI link interface each associated with the identifier, wherein the first EVI link interface interfaces with the first Hub-ED and the second EVI link interface interfaces with the second Hub-ED. The processor also sends the message to one of the first Hub-ED or the second Hub-ED via the EVI link interface selected from the set of EVI link interfaces.

### BACKGROUND

Ethernet Virtualisation Interconnection (EVI) technologies provide flexible layer-2 interconnection functions for sites networks (for example data centre sites) based on existing service provider (SP) networks and enterprise networks. EVI is a type of advanced “MAC (Media Access Control) in IP” technology to implement the Internet Protocol (IP) core network-based Layer-2 Virtual Private Network (L2VPN). An EVI network maintains routing and forwarding information on an edge device (ED) of a site network.

An EVI network may maintain routing and forwarding information on an edge device (ED) of a site network. In the present disclosure, the term “EVI” is used to describe such technologies, but other terms may be used by a person skilled in the art to describe the same or similar functions or technologies without departing from the scope of the present disclosure.

### BRIEF DESCRIPTION OF THE DRAWINGS

Features of the present disclosure are illustrated by way of non-limiting examples, and like numerals indicate like elements, in which:

FIG. 1 is a schematic diagram of an example Ethernet Virtualisation Interconnection (EVI) network having a Hub-Spoke structure;

FIGS. 2A to 2C are schematic diagrams of example Spoke-EDs;

FIG. 3 is a schematic flow chart of an example message transmission process;

FIGS. 4A, 4B are schematic diagrams of example forwarding tables for Spoke-EDs;

FIGS. 5A, 5B are schematic diagrams of example forwarding tables for Hub-EDs;

FIGS. 6A to 6T are schematic diagrams of example forwarding tables;

FIG. 7 is a schematic flow chart of an example forwarding table update process;

FIG. 8 is a schematic flow chart of an example address synchronisation process;

FIG. 9 is a schematic flow chart of an example forwarding table update process;

FIG. 10 is a schematic flow chart of an example failure processing process; and

FIG. 11 is a schematic flow chart of an example failure recovery process.

### DETAILED DESCRIPTION OF THE INVENTION

In an Ethernet Virtualisation Interconnection (EVI) network having at least one Hub-ED and a plurality of Spoke-EDs, the Hub-ED and the plurality of Spoke-EDs may be organised as a Hub-Spoke structure. In the Hub-Spoke structure, Spoke-EDs do not communicate with each other directly; instead, traffic between the Spoke-EDs is directed through the Hub-ED.

The present disclosure describes an example of device for use in an Ethernet Virtualisation Interconnection (EVI) network having a Hub-Spoke structure. The device, which is capable of acting as a spoke ED, comprises a memory unit to store instructions; and a processor to perform the instructions from the memory unit. The processor receives a message having an identifier, the identifier identifying a destination address of the message. The processor selects an EVI link interface from a set of EVI link interfaces having a first EVI link interface and a second EVI link interface each associated with the identifier, wherein the first EVI link interface interfaces with the first Hub-ED and the second EVI link interface interfaces with the second Hub-ED. The processor also sends the message to one of the first Hub-ED or the second Hub-ED via the EVI link interface selected from the set of EVI link interfaces.

The above example of the device implements message forwarding and forwarding table update in the EVI network having the Hub-Spoke structure. The above example may reduce the data processing burden on the Hub-EDs, and improve robustness of connection between Spoke-EDs. Further, the above method may facilitate data management functions by Hub-CEs in a centralised way in the EVI network.

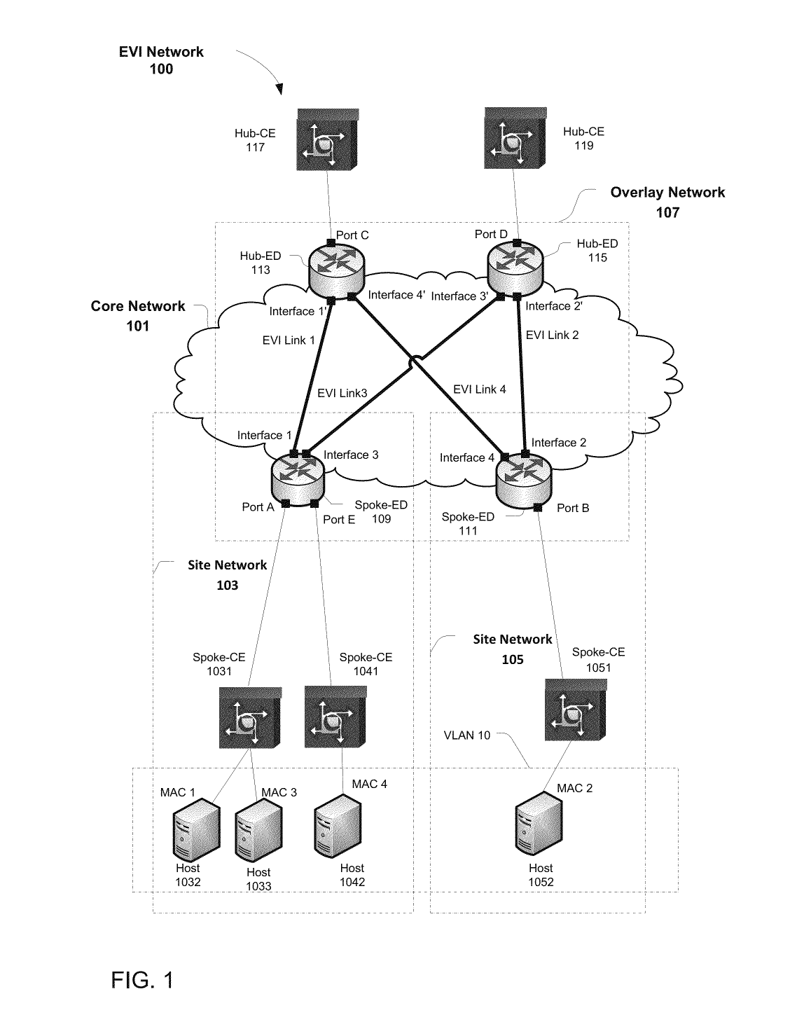

In an example shown in FIG. 1, a communication network 100 using EVI technologies, referred to as an EVI network 100, includes a core network 101, site networks 103, 105 and an overlay network 107.

The core network 101 is a network including IP routing devices and used by edge devices in the overlay network 107 to provide interconnection between the edge devices by performing IP forwarding of tunnel messages exchanged between EDs in the overlay network 107.

The site network 103, 105 is a layer-2 network that has independent service functions and is connected to the core network through an edge device (ED), for example Spoke-EDs 109, 111 in this example. The site network 103, 105 is individually organized, managed, controlled and maintained by a user. In the site network 103, 105, a Spoke Client Edge (Spoke-CE) device 1031, 1041, 1051 is connected to hosts belonging to a Virtual Local Area Network (VLAN) 10 across the site networks 103, 105. The Spoke-ED 109, 111 through which the site network 103, 105 is connected to the core network 101 provides layer-2 switching functions between site networks 103, 105.

There are hosts connected to the Spoke-CE in each of the site networks 103, 105. For example, hosts 1032, 1033 are connected to the Spoke-CE 1031 in the site network 103, a host 1042 is connected to the Spoke-CE 1041 in the site network 103, and a host 1052 is connected to the Spoke-CE 1051 in the site network 105. Each of the hosts 1032, 1033, 1042, 1052 has a Media Access Control (MAC) address. In this example, as shown in FIG. 1, the MAC address of the host 1032 is MAC 1, the MAC address of the host 1033 is MAC 3, the MAC address of the host 1042 is MAC 4, and the MAC address of the host 1052 is MAC 2.

An edge device 109, 111, 113 and 115 is a switching device that executes EVI functions, which operates as a layer-2 device at the site network 103, 105 side and operates as a layer-3 device at the core network 101 side. It performs mapping and forwarding of a message from the site network 103, 105 to an EVI tunnel and from the EVI tunnel to the site network 103, 105.

The overlay network 107 is a virtual network including EDs 109, 111, 113, 115, which provides layer-2 interconnection between site networks 103, 105, providing VLAN 10 with expandability across the different site networks 103, 105. The overlay network 107 carries layer-2 data streams of the VLAN 10 expanding across the site networks 103, 105 on a data plane, notifies each other of accessibility information of MAC addresses of the hosts 1032, 1033, 1042, 1052 in the site networks 103, 105 connected to the Spoke-EDs 109, 111 via the IGP (Interior Gateway Protocol) protocol on a control plane. As a result, the site networks 103, 105 are interconnected as a larger layer-2 forwarding domain.

Within the overlay network 107, EDs 109, 111, 113, 115 perform transparent data transmission via bi-directional EVI links 1, 2, 3 and 4 in FIG. 1. The EVI links 1, 2, 3, 4 are carried on an EVI tunnel between EDs 109, 111, 113, 115. Each EVI tunnel can carry a plurality of EVI links.

The EDs 109, 111, 113, 115 in the overlay network 107 are organised in a form of a Hub-Spoke structure, in which EDs 109 and 111 are Spoke-EDs and EDs 113 and 115 are Hub-EDs.

In the overlay network 107, the Hub-EDs 113, 115 operate as EVI Neighbor Discovery Server (ENDS), and the Spoke-EDs 109, 111 operate as EVI Neighbor Discovery Client (ENDC). The Hub-EDs 113 and 115, as ENDSs, maintain all neighbour information in the overlay network 107. However, at the same time, the ENDSs are also ENDCs.

In the example shown in FIG. 1, the Spoke-ED 109, 111 sends registration messages to the Hub-EDs 113, 115 advising that the Spoke-ED 109, 111 is an ENDC in the overlay network 107. The Hub-EDs 113, 115 learn, from the registration messages received from the Spoke-ED 109, 111, information about the ENDC in the overlay network 107 and maintain the information. In response to the registration messages, the Hub-ED 113, 115 sends a registration response message to Spoke-EDs 109, 111, respectively, advising that the Hub-ED 113, 115 is an ENDS in the overlay network 107.

Upon receipt of the registration response message at the Spoke-ED 109, 111, an EVI link is established between the Spoke-ED 109, 111 and the Hub-ED 113, 115, for example, the EVI link 1 between the Spoke-ED 109 and the Hub-ED 113, the EVI link 3 between the Spoke-ED 109 and the Hub-ED 115, the EVI link 2 between the Spoke-ED 111 and the Hub-ED 113, the EVI link 4 between the Spoke-ED 111 and the Hub-ED 115.

It should be noted that, in the EVI network 100 having the Hub-Spoke structure, there is no EVI link established between the Spoke-ED 109 and the Spoke-ED 111, communications between the Spoke-ED 109 and the Spoke-ED 111 need to be forwarded via a Hub-ED being the Hub-ED 113 or the Hub-ED 115. This way the Spoke-ED 109 and the Spoke-ED 111 do not communicate with each other directly.

For example, if the Spoke-ED 109 has a message to transmit to the Spoke-ED 111, the Spoke-ED 109 needs to transmit the message to the Hub-ED 113 or 115, then the message is forwarded to a Hub-CE 117, 119 connected to the Hub-ED 113 or 115 for data management purpose for example data monitoring and statistics. The Hub-CE 117, 119 then sends the message back to the Hub-ED 113, 115, which in turn transmits the message to the Spoke-ED 111. This way the traffic between the Spoke-EDs 109 and 111 can be monitored by the Hub-CE 117, 119.

Further, in the example shown in FIG. 1, two Hub-EDs 113 and 115 are included in the overlay network 107. The Hub-EDs 113 and 115 operate at the same time to reduce the burden of processing messages at the Hub-EDs 113 and 115.

In another example, the Hub-ED 113 and 115 operate in a back-up mode in which the Spoke-ED 109, 111 communicates with one of the Hub-EDs 113 115 with the other one as a back-up Hub-ED. For example, the Spoke-EDs 109, 111 communicates with the Hub-ED 113 with the Hub-ED 115 as the back-up Hub-ED. When the Hub-ED 113 is not available due to its own failure or failure of one of the EVI links 1, 4, the Spoke-EDs 109, 111 communicate with the back-up Hub-ED 115. As a result of the back-up mode, robustness of the connection between the Spoke-EDs 109 and 111 is improved.

Whether the Hub-ED 113 and 115 operate in a back-up mode or not, if the Hub-ED 113 is not available due to its own failure, the Spoke-EDs 109, 111 detect unavailability of the Hub-ED113 through status of the EVI links 1, 4.

On the other hand, if one of the EVI links 1, 4 fails, for example the EVI link 1, the Spoke-ED 109 detects the unavailability of the Hub-ED 113 through the status of the EVI link 1, while the Spoke-ED 111 is advised of unavailability of the Hub-ED 113 through a message sent from the Hub-ED 113 over the EVI link 4.

If the Hub-ED 113 recovers from its own failure, the Spoke-EDs 109, 111 determine availability of the Hub-ED 113 by detecting statues of the EVI links 1, 4.

On the other hand, if the failure of the EVI link 1 is fixed, the Spoke-ED 109 detects the availability of the Hub-ED 113 through the status of the EVI link 1, while the Spoke-ED 111 is advised of availability of the Hub-ED 113 through a message sent from the Hub-ED 113 over the EVI link 4.

Prior to describing the example shown in FIG. 1 in detail, the relationships between the EDs, EVI links, ports and EVI link interfaces in FIG. 1 are summarised as follows:
Port A: a port on the Spoke-ED 109 via which the Spoke-ED 109 is connected to the Spoke-CE 1031;
Port B: a port on the Spoke-ED 111 via which the Spoke-ED 111 is connected to the Spoke-CE 1051;
Port C: a port on the Hub-ED 113 via which the Hub-ED 113 is connected to the Hub-CE 117;
Port D: a port on the Hub-ED 115 via which the Hub-ED 115 is connected to the Hub-CE 119;
Port E: a port on the Spoke-ED 109 via which the Spoke-ED 109 is connected to the Spoke-CE 1041;
EVI link 1: an EVI link connecting the Spoke-ED 109 to the Hub-ED 113;
EVI link 2: an EVI link connecting the Spoke-ED 111 to the Hub-ED 115;
EVI link 3: an EVI link connecting the Spoke-ED 109 to the Hub-ED 115;
EVI link 4: an EVI link connecting the Spoke-ED 111 to the Hub-ED 113;
EVI link interface 1 (denoted as Interface 1 in FIG. 1): an interface on the Spoke-ED 109 interfacing with the Hub-ED 113 via the EVI link 1;
EVI link interface 2 (denoted as Interface 2 in FIG. 1): an interface on the Spoke-ED 111 interfacing with the Hub-ED 115 via the EVI link 2;
EVI link interface 3 (denoted as Interface 3 in FIG. 1): an interface on the Spoke-ED 109 interfacing with the Hub-ED 115 via the EVI link 3;
EVI link interface 4 (denoted as Interface 4 in FIG. 1): an interface on the Spoke-ED 111 interfacing with the Hub-ED 113 via the EVI link 4;
EVI link interface 1′ (denoted as Interface 1′ in FIG. 1): an interface on the Hub-ED 113 interfacing with the Spoke-ED 109 via the EVI link 1;
EVI link interface 2′ (denoted as Interface 2′ in FIG. 1): an interface on the Hub-ED 115 interfacing with the Spoke-ED 111 via the EVI link 2;
EVI link interface 3′ (denoted as Interface 3′ in FIG. 1): an interface on the Hub-ED 115 interfacing with the Spoke-ED 109 via the EVI link 3; and
EVI link interface 4′ (denoted as Interface 4′ in FIG. 1): an interface on the Hub-ED 113 interfacing with the Spoke-ED 111 via the EVI link 4.

Messages Transmissions at the Spoke-EDs

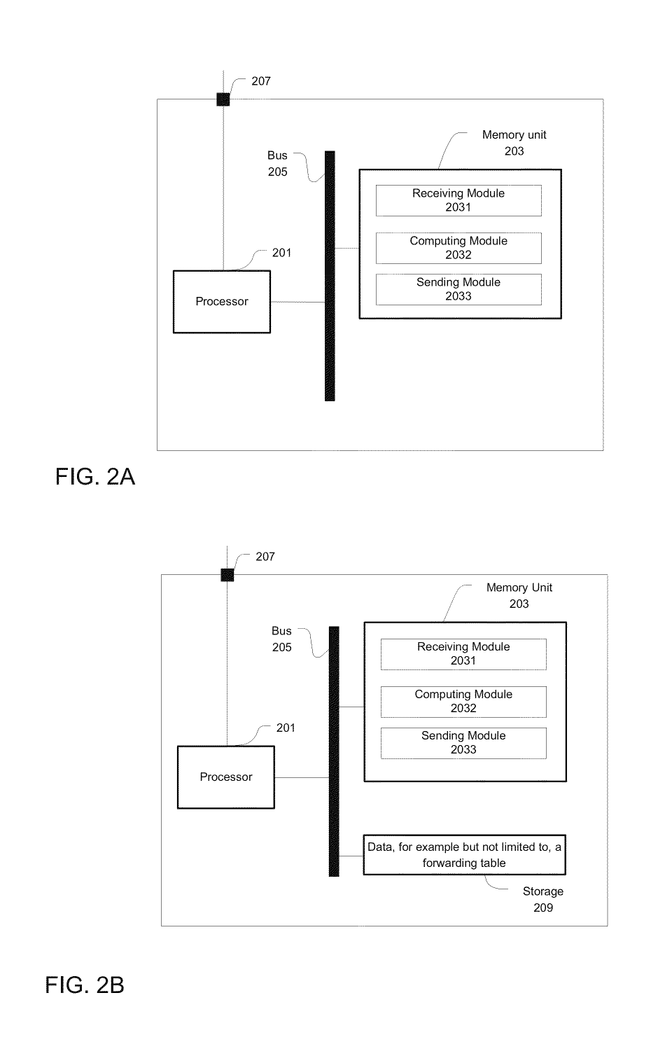

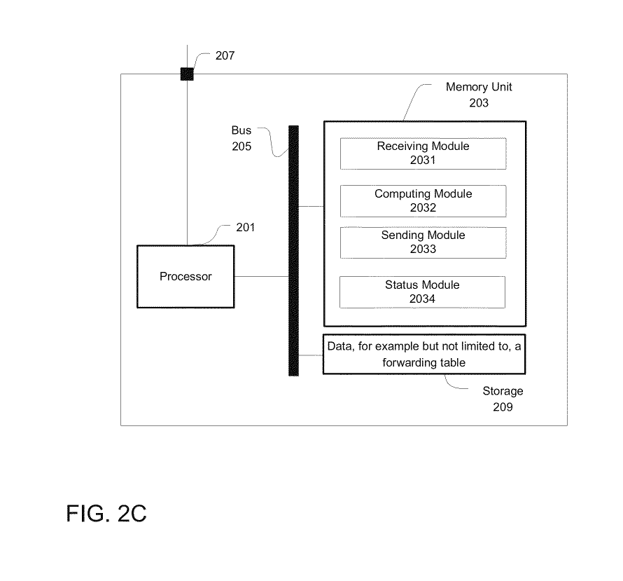

Examples of the Spoke-EDs 109, 111 are shown in FIG. 2A.

As the Spoke-EDs 109, 111 operate in a similar way in the example shown in FIG. 1, in the Spoke-ED 109 is taken as an example in the description below unless otherwise stated.

The example Spoke-ED 109 shown in FIG. 2A includes a processor 201, a memory unit 203, a bus 205 and at least one port 207. The memory unit 203 stores instructions for the processor 201 to implement functions of the Spoke-ED 109. The port 207 may be implemented as a physical or logical port for use as the Port A or E, or the EVI link interface 1 or 3 of the Spoke-ED 109.

The processor obtains the instructions from the memory unit 203 via the bus 205. In this example, the instructions are stored in function modules of the memory unit 203, for example, a receiving module 2031, a computing module 2032, and a sending module 2033.

In this example, the processor 201 performs the instructions in the receiving module 2031 to receive messages from the site network 103 (for example, an Ethernet message from the Spoke-CEs 1031, 1041), and messages from the overlay network 107 (for example, an EVI message received form the Hub-EDs 113 or 115 over the EVI links 1 or 3).

The processor 201 performs the instructions in the computing module 2032 to select an EVI link interface from a set of EVI link interfaces for an Ethernet message received from the Spoke-CE 1031, 1041 according to an identifier of the Ethernet message identifying a destination address of the Ethernet message. The set of EVI link interfaces has EVI link interfaces associated with the identifier. In this example, the set of EVI link interfaces has the EVI link interfaces 1, 3. In another example, the set of EVI link interface have more EVI link interfaces.

The processor 201 searches a forwarding table for the corresponding EVI link interfaces 1 and 3 of the Spoke-ED 109 according to a VLAN identifier and a destination MAC address of an Ethernet message received by the Spoke-ED 109 from the Spoke-CE 1031, 1041. The processor 201 then selects an EVI link interface from the EVI link interfaces 1 and 3, which may be performed based on a predetermined load sharing rule.

In this example, the processor 201 performs the instructions from the sending module 2033 to encapsulate the Ethernet message received by the Spoke-ED 109 from the Spoke-CE 1031, 1041 according to the EVI link interface selected by the processor 201 to construct an EVI message and send the EVI message to the Hub-ED 113, 115 via the EVI link interface.

In this example, the processor 201 further performs the instructions from the computing module 2032 to decapsulates an EVI message received by the Spoke-ED 109 from the overlay network 107 to obtain an Ethernet message contained in the EVI message. The processor further searches the forwarding table for a port being A or E according to a VLAN identifier and a destination MAC address contained in the Ethernet message. The processor 201 also performs the instructions from the sending module 2032 to send the Ethernet message via the port being A or E.

Forwarding Table Update at the Spoke-EDs

Other examples of the Spoke-EDs 109, 111 are shown in FIG. 2B. The Spoke-ED 109 is taken as an example in the description below unless otherwise stated. The example Spoke-ED 109 shown in FIG. 2B, in addition to the elements shown in FIG. 2A, further includes a storage 209.

The storage 209 of the Spoke-ED 109 stores data for functions of the Spoke-ED 109. In this example the storage 209 stores a forwarding table for forwarding messages within the overlay network 107.

The processor 201 further performs the instructions from the computing module 2032 to update and store the forwarding table in the storage 209 as described below.

In this example, the Spoke-ED 109 receives a message from the Spoke-CE 1031 via the Port A. The processor 201 extracts an identifier, which includes a VLAN identifier and a source MAC address, from the message and generates an entry for the forwarding table, in which the VLAN identifier and the source MAC address of the message received are associated with the Port A. The processor 201 further stores the entry in the storage 209.

In this example, the identifier is directly extracted from the message. In another example, the extracting of the identifier may include further processing for example decoding, decryption, etc.

The processor 201 further generates an entry for the forwarding table, in which the EVI link interfaces 1, 3 of the Spoke-ED 109 are associated with the VLAN identifier and the source MAC address of the message. The processor 201 further stores the entry in the storage 209.

The processor 201 further generates a first EVI synchronisation message and a second EVI synchronisation message, including the source MAC address and the VLAN ID, and sends the EVI synchronisation messages to the Hub-EDs 113, 115 via the EVI link interfaces 1 and 3, respectively. This way the source MAC address of the message, which is the MAC address of host 1032 or 1033 in the site network 103, and the VLAN ID are synchronised by the Spoke-ED 109 to the Hub-EDs 113, 115, and are further synchronised to the Spoke-ED 111 by the Hub-EDs 113, 115.

On the other hand, in this example, the Spoke-ED 109 may receive a first EVI synchronisation message from the Hub-ED 113 over the EVI link 1 via the EVI link interface 1 and a second synchronisation message from the Hub-ED 115 over the EVI link 3 via the EVI link interface 3. The first synchronisation message and the second synchronisation message are initiated by the Spoke-ED 111 as described above with reference to Spoke-ED 109. The first synchronisation message and the second synchronisation message have a same VLAN identifier and a same MAC address, which represents a host being the host 1052 in the site network 105. The processor 201 extracts the VALN identifier and the MAC address, and generates an entry for the forwarding table of the Spoke-ED 109, in which the EVI link interfaces 1, 3 of the Spoke-ED 109 are associated with the VLAN identifier and the MAC address. The processor 201 further stores the entry in the storage 209.

In this example, the processor 201 further performs the instructions from the computing module 2032 to generate an entry for the forwarding table, in which a VLAN identifier and a broadcast MAC address are associated with the EVI link interfaces 1, 3. The processor 201 further stores the entry in the storage 209.

The processor 201 further performs the instructions from the computing module 2032 to generate an entry for the forwarding table, in which the VLAN identifier and the broadcast MAC address are associated with the Port A. The processor 201 further stores the entry in the storage 209.

Failure Processing

Other examples of the Spoke-EDs 109, 111 are shown in FIG. 2C. The Spoke-ED 109 is taken as an example in the description below unless otherwise stated. In this example, the memory unit 203 of the Spoke-ED 109 further includes a status module 2034. The processor 201 further performs the instructions from the computing module 2032 and the status module 2034 shown in FIG. 2C to perform failure processing functions when the Hub-ED 113 or 115 fails and the Hub-ED 113 or 115 recovers from the failure.

In this example, the processor 201 determines unavailability of the Hub-ED 113 due to a failure as described above. The processor 201 removes the EVI link interface 1, which interfaces with the Hub-ED 113, from the forwarding table.

During the period of the failure, the Spoke-ED 109 receives a message from the Spoke-CE 1031 via the Port A.

The processor 201 extracts a VLAN identifier and a source MAC address from the message and generates an entry for the forwarding table, in which the VLAN identifier and the source MAC address of the message are associated with the Port A. The processor 201 further stores the entry in the storage 209.

The processor 201 further identifies the EVI link interface 3, which interfaces with the Hub-ED 115 that works normally, and generates an entry for the forwarding table, in which the EVI link interfaces 3 is associated with the VLAN identifier and the source MAC address of the message. The processor 201 further stores the entry in the storage 209.

The processor 201 further generates an EVI synchronisation message including the VLAN identifier and the source MAC address of the message.

The processor 201 further performs the instructions from the sending module 2033 to send the EVI synchronisation message to the Hub-ED115 via the EVI link interface 3. This way the source MAC address of the message, which is the MAC address of host 1032 or 1033 in the site network 103, is synchronised by the Spoke-ED 109 to the Hub-ED 115 and are further synchronised to the Spoke-ED 111 by the Hub-ED 115.

In this example, the processor 201 determines availability of the Hub-ED 113 due to recovery of the failure, the processor 201 stores the EVI link interface 1 in association with the MAC addresses and the VLAN identifiers in the forwarding table. The processor 201 generates an EVI synchronisation message having the VLAN identifier and the MAC address that the Spoke-ED 109 has learnt during the period that Hub-ED 113 fails, as described in detail with reference to the method flow of the Spoke-ED 109.

The processor 201 further performs the instructions from the sending module 2033 to send the EVI synchronisation message to the Hub-ED 113 via the EVI link interface 1. This way the VLAN identifier and the new MAC address are synchronised to the Hub-ED 113 and in turn to the Spoke-ED 111.

### Example Implementations

### Message Transmission at Spoke-EDs

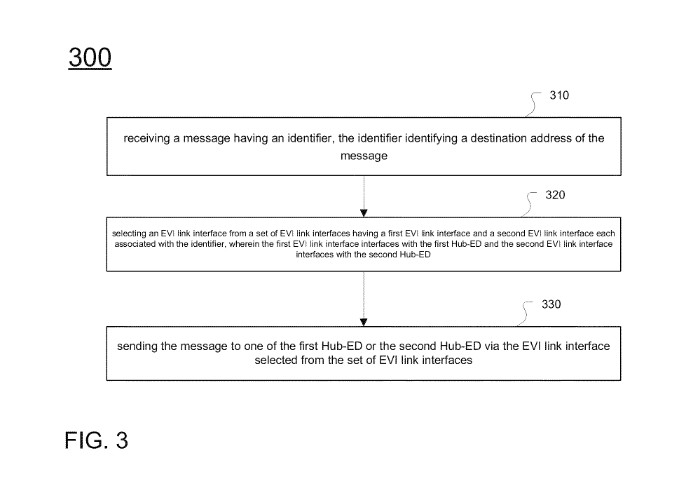

An example message transmission process at the Spoke-EDs 109, 111 shown in FIG. 2B is described with reference to FIGS. 1, 3 and 4A.

The host 1032 in the site network 103, the MAC address of which is MAC 1 as shown in FIG. 1, has an Ethernet message to transmit to the host 1052 in the site network 105. The Ethernet message contains a source identifier identifying a source address of the Ethernet message and a destination identifier identifying a destination address of Ethernet message. In the example shown in FIG. 1, as one VLAN 10 is shown and the host 1032 in the site network 103 and the host 1052 in the site network 105 belong to the same VLAN, i.e., VLAN 10, the MAC addresses of the hosts 1032, 1052 can be used to identify the hosts 1032, 1052. For ease of extending this example to EVI networks having more than one VLAN identifiers (VLAN ID), a combination of a VLAN ID and a MAC address is used to identify a host in a site network in the description below. The identifier may also take other forms that can uniquely identify the respective hosts in the site networks.

In this example, the Ethernet message contains a VLAN ID of 10, a source MAC address of MAC 1 identifying the host 1032, a destination MAC address of MAC 2 identifying the host 1052.

The host 1032 sends the Ethernet message to the Spoke-CE 1031, which in turn sends the Ethernet message to the Spoke-ED 109.

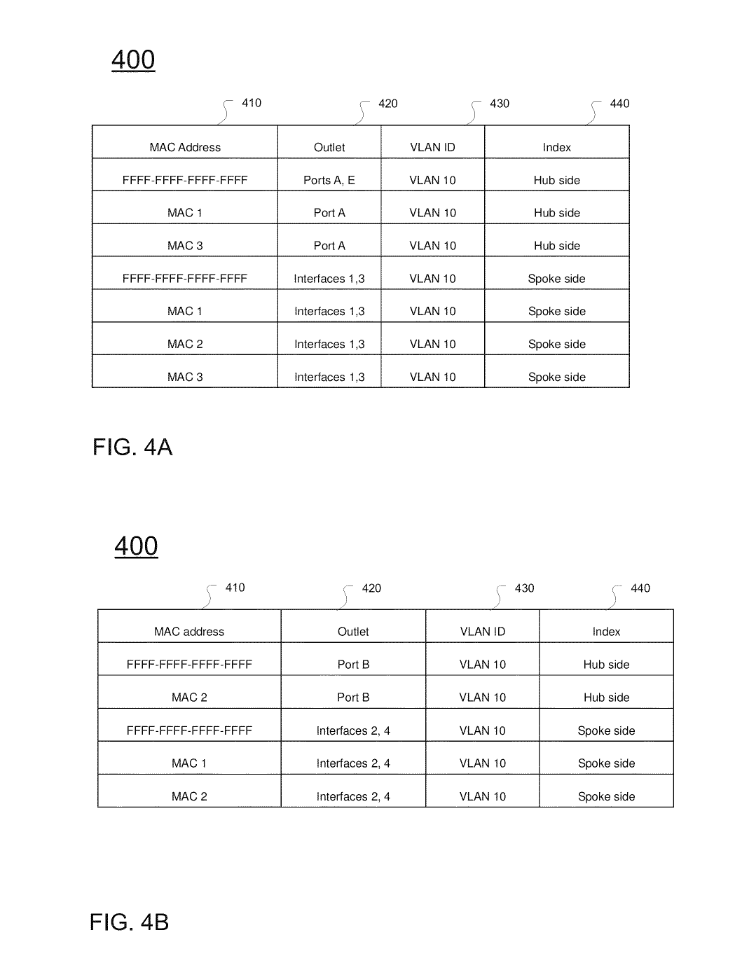

The Spoke-ED 109 includes the forwarding table 400 shown in FIG. 4A. The forwarding table 400 contains entries for forwarding messages received by the Spoke-ED 109. The forwarding table 400 includes a MAC address field 410, an Outlet field 420, a VLAN ID field 430 and Index field 440. The MAC address field 410 contains a MAC address included in a message received at the Spoke-ED 109. The outlet field 420 contains a port or EVI link interfaces to which the message is forwarded. The VLAN ID field 430 contained a VLAN ID included in the message. The Index field 440 contains an index indicating that an entry is for forwarding a message received from Hub-EDs or Spoke-CEs. In this example, the index has two values, “Hub side” and “Spoke side”. If the Spoke-ED 109 receives a message from the Hub-EDs 113 or 115, the Spoke-ED 109 searches the entries having the index value of “Hub side”. On the other hand, if the Spoke-ED 109 receives a message from the Spoke-CEs 1031 or 1041, the Spoke-ED 109 searches the entries having the index value of “Spoke side”.

Upon receipt 310 of the Ethernet message from the Spoke-CE 1031 at the Spoke-ED 109, the Spoke-ED 109 determines the VLAN ID of VLAN 10 and the destination MAC address of MAC 2, which is the MAC address of the host 1052.

The Spoke-ED 109 then searches the forwarding table 400 shown in FIG. 4A for EVI link interfaces associated with the VLAD ID 10 and the destination MAC address MAC 2 of the Ethernet message. As the message is received from the Spoke-CE 1031, the Spoke-ED 109 searches the entries in forwarding table 400 having the index value of “Spoke side”. As a result, in FIG. 4A, a set of EVI link interfaces having the EVI link interfaces 1, 3 are located by the Spoke-ED 109, which interface with the Hub-EDs 113 and 115, respectively.

The Spoke-ED 109 selects 320 the EVI link interface 1 from the set of EVI link interface as the EVI link interface via which the message is forwarded.

The Spoke-ED 109 encapsulates the Ethernet message according to the EVI link interface 1 to construct an EVI message. Then the Spoke-ED 109 sends 330 the EVI message to the Hub-ED 113 over the EVI link 1 via the EVI link interface 1. In the above description, the selection of the EVI link interface 1 may be based on a predetermined load sharing rule. An example load sharing rule is Hash modulo rule. In the Hash modulo rule, attribute information of the Ethernet message is subject to a Hash function. If the result of the Hash function modulo 2 is 1, then the EVI link interface 1 is selected, otherwise the EVI link interface 3 is selected. It should be noted that the attribute information of the Ethernet message may include but not limited to the following information: the source MAC address, the destination MAC address, an ingress port, a source IP address and a destination IP address.

On the other hand, in the example, the Spoke-ED 109 receives an EVI message from the Hub-ED 113. The EVI message contains an Ethernet message having a VLAN ID of VLAN 10 and destination MAC address of MAC 1 indicating the destination host of the Ethernet message is the host 1032.

The Spoke-ED 109 decapsulates the EVI message to obtain the Ethernet message and searches the forward table 400 shown in FIG. 4A. As the EVI message is received form the Hub-ED 113. The Spoke-ED 109 searches the entries in the forwarding table 400 having the index value of “Hub side” for an outlet associated with VLAN 10 and MAC 1. As a result, in FIG. 4A, the Port A is located by the Spoke-ED 109, via which the Spoke-ED 109 is connected to the Spoke-CE 1031. Then the Spoke-ED 109 sends the Ethernet message to the Spoke-CE 1031, which in turn sends the Ethernet message to the host 1032 according to the destination MAC address MAC 1.

Message Transmission at Hub-EDs

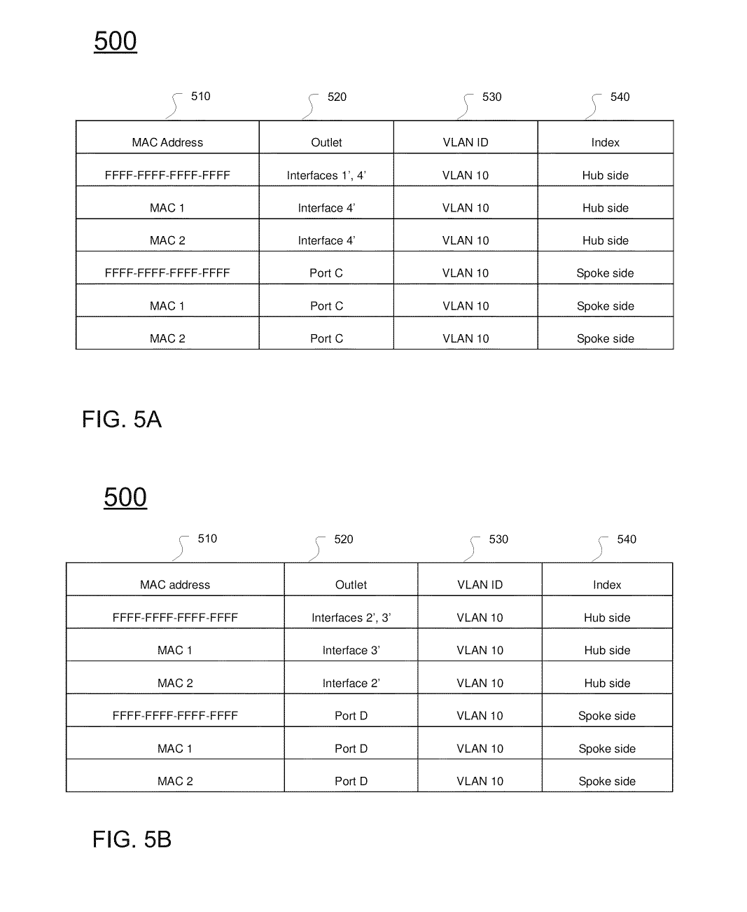

An example message transmission process at the Hub-EDs 113, 115 is described with reference to FIGS. 1 and 5A. In the following description, the Hub-ED 113 is taken as an example unless otherwise stated.

The Hub-ED 113 receives the EVI message sent from the Spoke-ED 109 over the EVI link 1 via the EVI link interface 1′ and decapsulates the EVI message to obtain the Ethernet message contained in the EVI message. Then Hub-ED 113 searches the example forwarding table 500 shown in FIG. 5A.

The forwarding table 500 includes a MAC address field 510, an Outlet field 520, a VLAN ID field 530 and Index field 540. The MAC address field 510 contains a MAC address included in a message received at the Hub-ED 113. The Outlet field 520 contains a port or EVI link interfaces to which the message is forwarded. The VLAN ID field 530 contained a VLAN ID included in the message. The Index field 540 contains an index indicating that an entry is for a message received from a Hub-CE or Spoke-EDs. In this example, the index has two values, “Hub side” and “Spoke side”. If the Hub-ED 113 receives a message from the Hub-CE 117, the Hub-ED 13 searches the entries having the index value of “Hub side”. On the other hand, if the Hub-ED 113 receives a message from the Spoke-EDs 109, 111, the Hub-ED 113 searches the entries having the index value of “Spoke side”.

As the EVI message is received from the Spoke-ED 109, the Hub-ED 1113 searches the entries in the forwarding table 500 having the index value of “Spoke side” for an outlet associated with the VLAD ID of VLAN 10 and the destination MAC address MAC 2 of the Ethernet message. As a result, in FIG. 5A, the Port C is found, via which the Hub-ED 113 is connected to the Hub-CE 117. The Hub-ED 113 then sends the Ethernet message to the Hub-CE 117. This way the Hub-CE 117, serving as a data traffic management device, perform message management functions for example data monitoring and statistics on the Ethernet message, and sends the Ethernet message to the Hub-ED 113.

Upon receipt of the Ethernet message from the Hub-CE 117, the Hub-ED 113 searches the entries in the forwarding table 500 in FIG. 5A having the index value “Hub side” for an outlet associated with the VLAD ID of VLAN 10 and the destination MAC address MAC 2 of the Ethernet message. In FIG. 5A, the EVI link interface 4′ is found, via which the Hub-ED 113 is connected to the Spoke-ED 111. Then Hub-ED 113 encapsulates the Ethernet message to generate an EVI message according to the EVI link interface 4′ and sends the EVI message to the Spoke-ED 111 over the EVI link 4 via the EVI link interface 4′.

Broadcast Message Transmission

The host 1032 in the site network 103 sends a broadcast Ethernet message having a source MAC address of MAC 1, a broadcast MAC address of FFFF-FFFF-FFFF-FFFF, and a VLAN ID of VLAN 10. The broadcast Ethernet message is received by the Spoke-CE 1031 and is broadcast by the Spoke-CE 1031 within the VLAN identified by VLAN 10.

Upon receipt of the broadcast Ethernet message at the Spoke-ED 109, the Spoke-ED 109 searches the forwarding table 400 shown in FIG. 4A. As the broadcast Ethernet message is received from the Spoke-CE 1031. The Spoke-ED 109 searches the entries in the forwarding table 400 having the index value of “Spoke side” for an outlet associated with the broadcast MAC address FFFF-FFFF-FFFF-FFFF and the VLAN of VLAN 10. As a result, a set of EVI link interfaces having the EVI link interfaces 1, 3 are found, as shown in the fourth entry for the forwarding table 400 in FIG. 4A. The Spoke-ED 109 selects one of the EVI link interfaces 1 or 3 according to a predetermined load sharing rule. In this example, the EVI link interface 3 is selected by the Spoke-ED 109. The Spoke-ED 109 encapsulates the broadcast Ethernet message based on the EVI link interface 3 to construct a broadcast EVI message and sends the broadcast EVI message to the Hub-ED 115 over the EVI link 3 via the EVI link interface 3. This way the broadcast EVI message containing the broadcast Ethernet message, which has the VLAN ID of VLAN 10 and the broadcast MAC address, is sent to the Hub-ED 115.

Upon receipt of the broadcast EVI message at the Hub-ED 115, the Hub-ED 115 decapsulates the broadcast EVI message to obtain the broadcast Ethernet message. As the broadcast EVI message is received from the Spoke-ED 109, the Hub-ED 115 search the entries having the index value of “Spoke side” in the forwarding table 500 shown in FIG. 5B for an outlet associated with VLAN 10 and the broadcast MAC address. As a result, the Port D is found. The Hub-ED 115 then sends the broadcast Ethernet message to Hub-CE 119 via the Port D.

Upon receipt of the broadcast Ethernet message at the Hub-CE 119, the Hub-CE 119 performs data management functions, for example data monitoring and statistics, and then sends the broadcast Ethernet message to the Hub-ED 115.

Upon receipt of the broadcast Ethernet message at the Hub-ED 115, the Hub-ED 115 searches entries in the forwarding table 500 shown in FIG. 5B. As the broadcast Ethernet message is received from the Hub-CE 119, the Hub-CE 115 searches the entries having the index value of “Hub side” for an outlet associated with VLAN 10 and the broadcast MAC address. As a result, the EVI link interfaces 2′ and 3′ are found.

The Hub-ED 115 encapsulates the broadcast Ethernet message according to the EVI link interface 2′ and 3′, respectively, to construct a first broadcast EVI message and a second broadcast EVI message. The Hub-ED 115 sends the first broadcast EVI message to the Spoke-ED 109 over the EVI link 3 via the EVI link interface 3′, and the second broadcast EVI message to the Spoke-ED 111 over the EVI link 2 via the EVI link interface 2′.

Upon receipt of the first broadcast EVI message at the Spoke-ED 109, the Spoke-ED 109 decapsulates the first broadcast EVI message to obtain the broadcast Ethernet message having the source MAC address of MAC 1. The Spoke-ED 109 searches entries having the index value of “Hub side” in the forwarding table 400 shown in FIG. 4A for an outlet associated with VLAN 10 and the broadcast MAC address. As a result, the Ports A, E are found.

However, the Spoke-ED 109 determines that the first broadcast EVI message is caused by the host 1032 in the site network 103 as the source MAC address of the broadcast Ethernet message is MAC 1. Therefore, the Spoke-ED 109 does not send the broadcast Ethernet message via the Port A, but sends the broadcast Ethernet message to the Spoke-CE 1041 via the Port E. The Spoke-CE 1041 in turn sends the broadcast Ethernet message to hosts connected therewith, i.e., the host 1042 in this example. In another example, only the Spoke-CE 1031 is connected to the Spoke-ED 109, the Spoke-ED 109 then discards the broad Ethernet message. This way the Spoke-ED 109 avoids the scenario of broadcasting a message to a host from which the message originates.

On the other hand, upon receipt of the second broadcast EVI message at the Spoke-ED 111, the Spoke-ED 111 decapsulates the second broadcast EVI message to obtain the broadcast Ethernet message. The Spoke-ED 111 searches entries having the index value of “Hub side” in the forwarding table 400 shown in FIG. 4B for an outlet associated with VLAN 10 and the broadcast MAC address. As a result, the Port B is found. The Spoke-ED 111 then sends the broadcast Ethernet message to the Spoke-CE 1051 via the Port B.

The Spoke-CE 1051 in turn sends the broadcast Ethernet message to hosts connected therewith, i.e., the host 1052 in this example.

Forwarding Table Update Processes at the Edge Devices

For simplicity of description, the forwarding table update processes for the Spoke-ED 1041 in the site network 103 are not described below.

Forwarding Table Update for Broadcast Messages

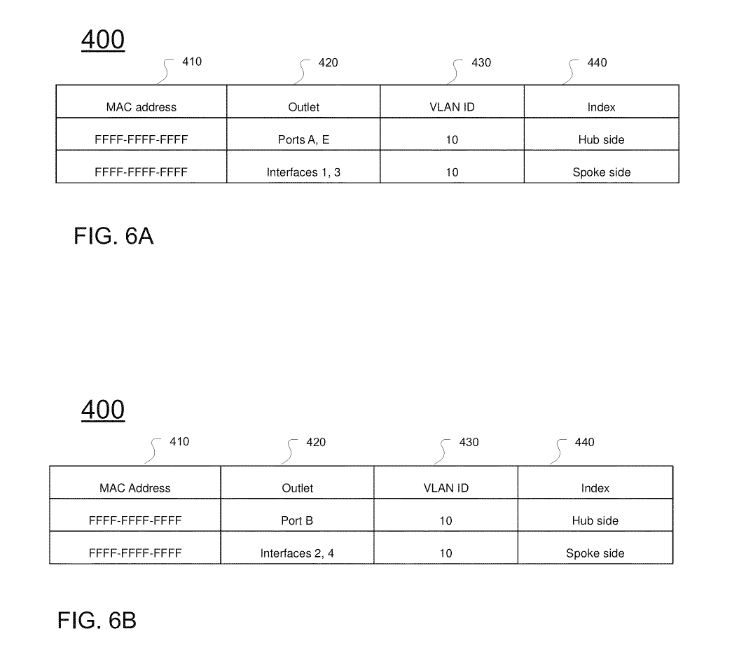

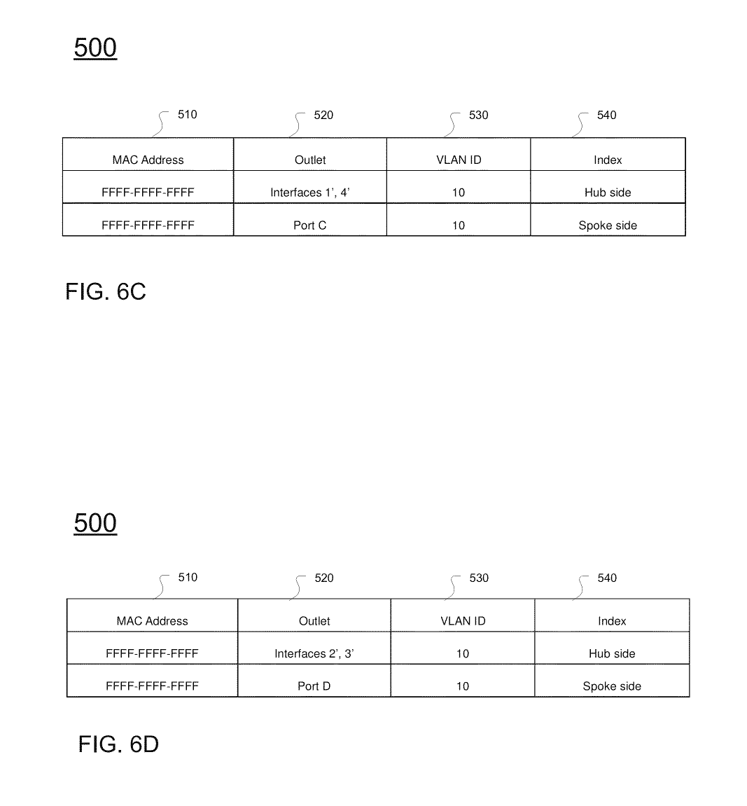

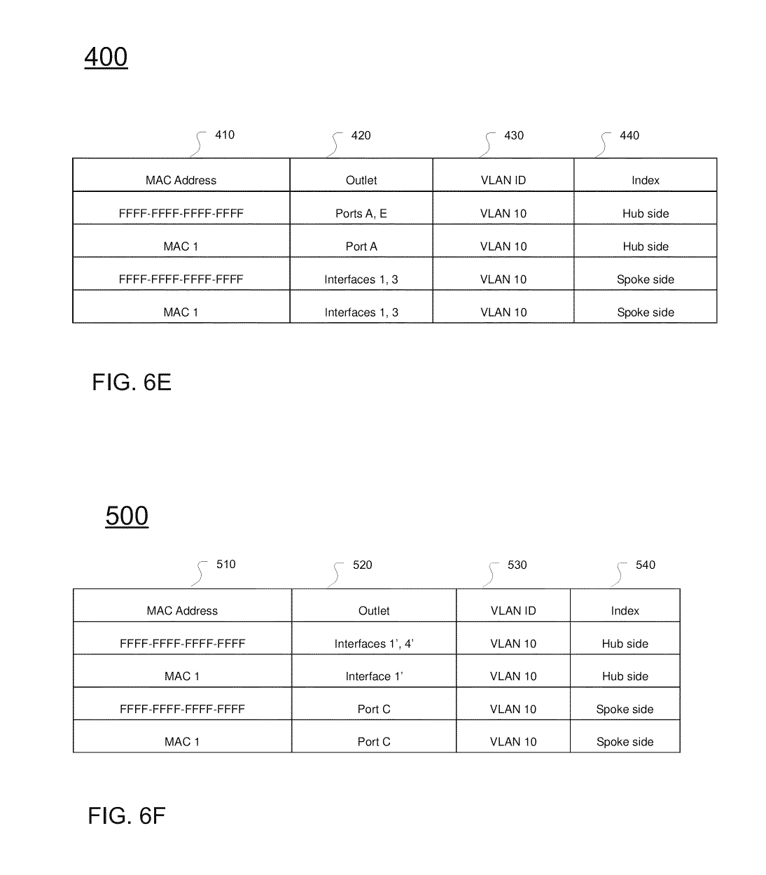

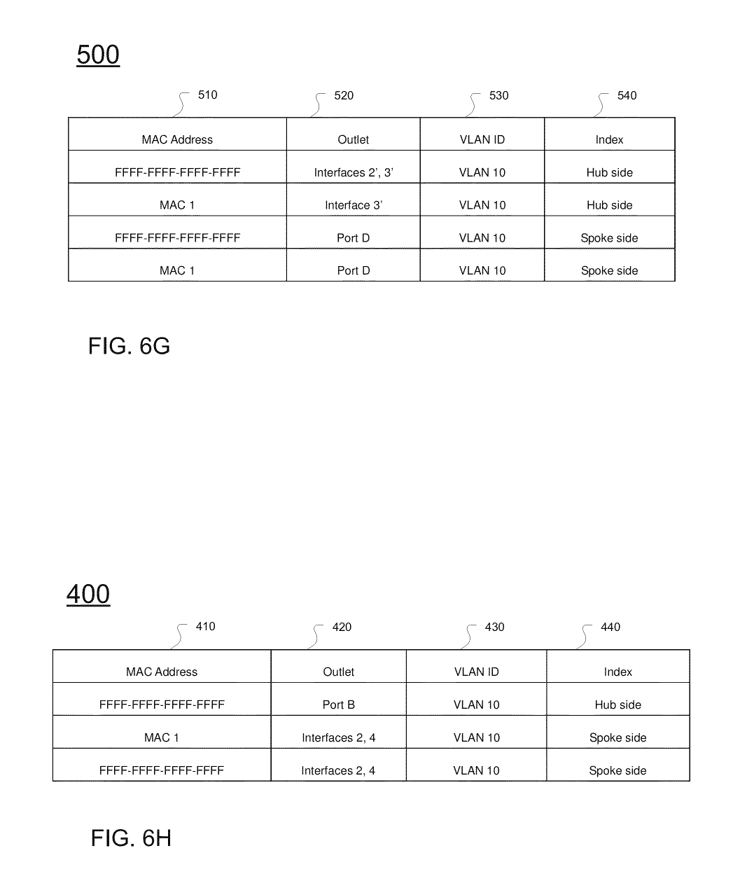

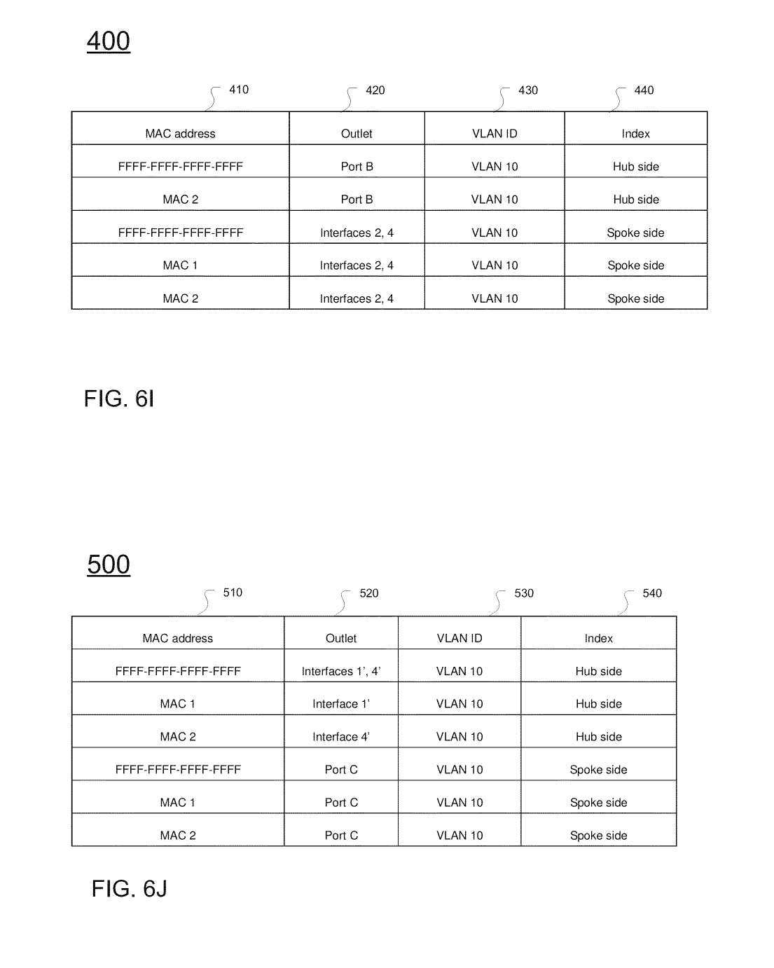

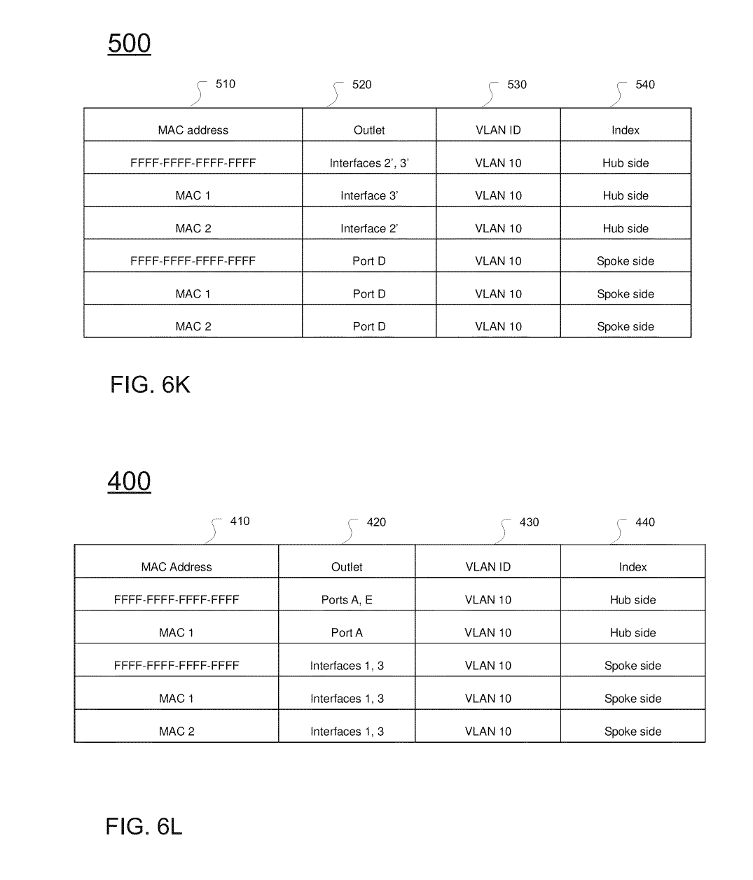

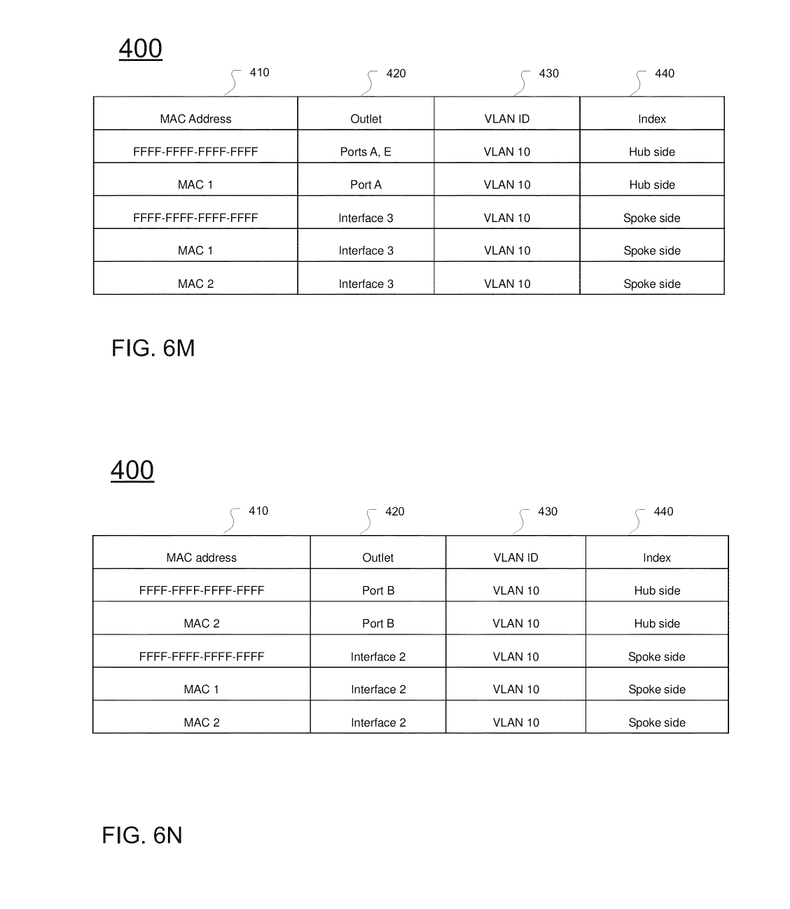

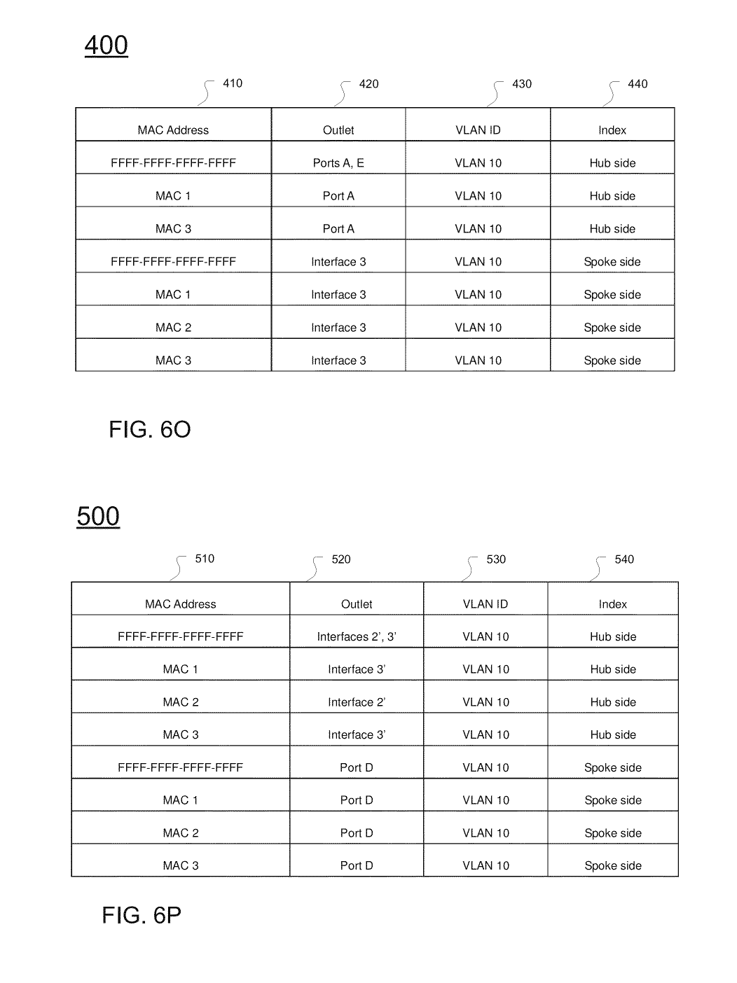

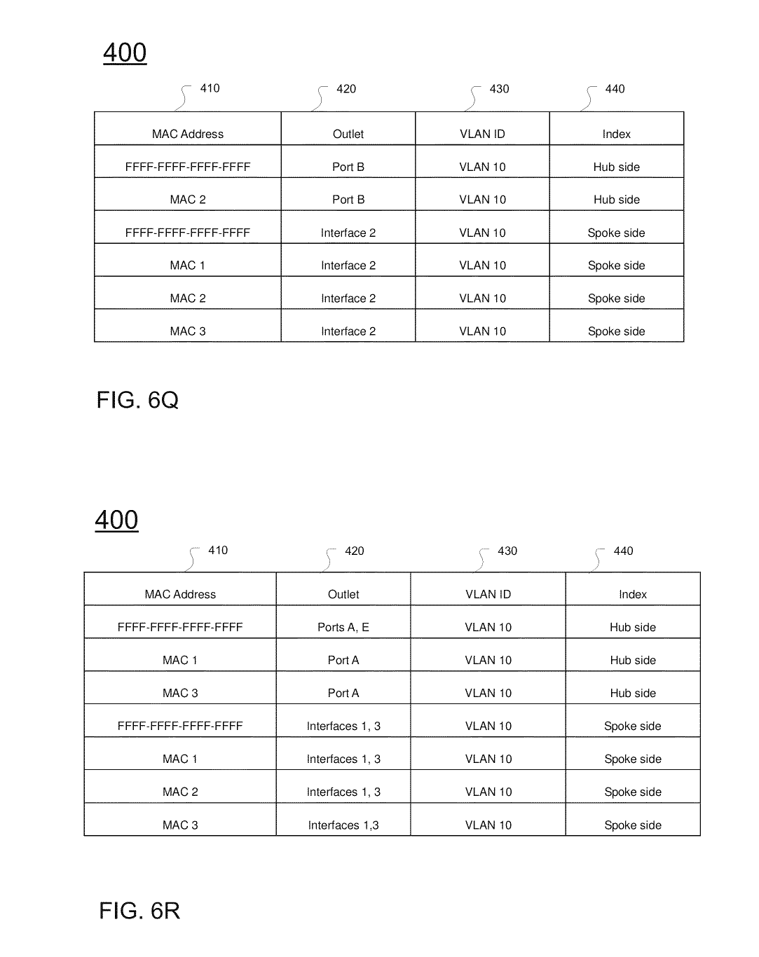

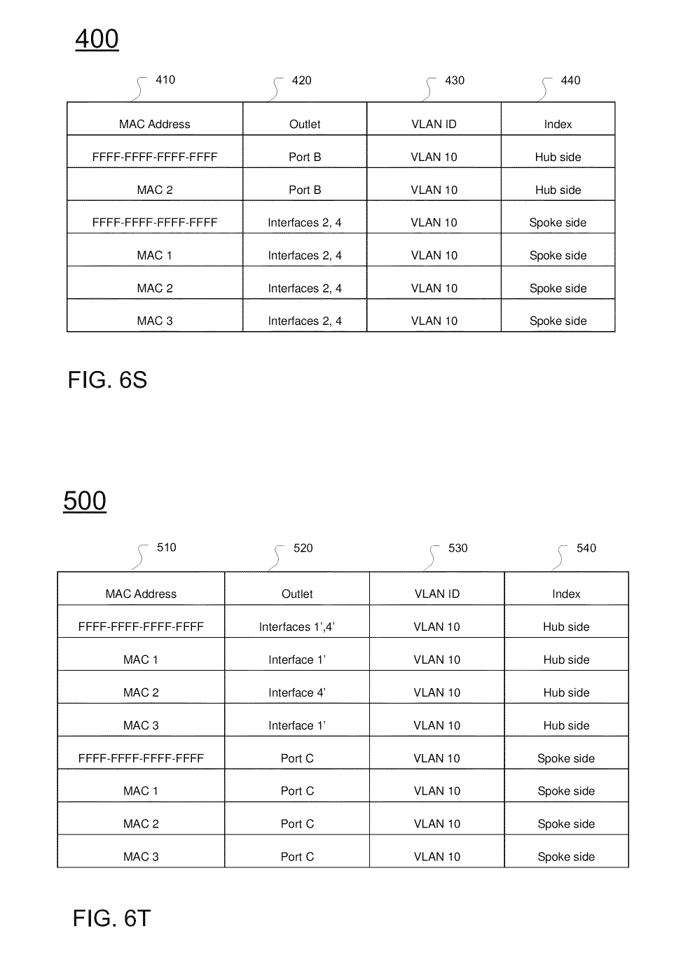

Forwarding table update processes for broadcast messages are described below with reference to FIGS. 6A to 6D.

In this example, the destination message of a broadcast message in a VLAN identified by a VLAN ID of VLAN 10 is FFFF-FFFF-FFFF-FFFF.

The Spoke-ED 109 generates two entries for a broadcast message. In the entry having the index value of “Hub side”, the broadcast MAC address is associated with the Ports A, E, VLAN 10. In the entry having the index value of “Spoke side”, the broadcast MAC address is associated with the EVI link interfaces 1, 3 and VLAN 10. The Spoke-ED 109 stores these entries in the forwarding table 400 for the Spoke-ED 109 shown in FIG. 6A.

The Spoke-ED 111 generates two entries for a broadcast message. In the entry having the index value of “Hub side”, the broadcast MAC address is associated with the Port B, VLAN 10. In the entry having the index value of “Spoke side”, the broadcast MAC address is associated with the EVI link interfaces 2, 4 and VLAN 10. The Spoke-ED 111 stores these entries in the forwarding table 400 for the Spoke-ED 111 shown in FIG. 6B.

The Hub-ED 113 generates two entries for a broadcast message. In the entry having the index value of “Hub side”, the broadcast MAC address is associated with the EVI link interfaces 1′, 4′ and VLAN 10. In the entry having the index value of “Spoke side”, the broadcast MAC address is associated with the Port C and VLAN 10. The Hub-ED 113 stores these entries in the forwarding table 500 for the Hub-ED 113 shown in FIG. 6C.

The Hub-ED 115 generates two entries for a broadcast message. In the entry having the index value of “Hub side”, the broadcast MAC address is associated with the EVI link interfaces 2′, 3′ and VLAN 10. In the entry having the index value of “Spoke side”, the broadcast MAC address is associated with the Port D and VLAN 10. The Hub-ED 115 stores these entries in the forwarding table 500 for the Hub-ED 115 shown in FIG. 6D.

Forwarding Table Update for Unicast Messages at the Edge Devices (from the Spoke-ED 109 to the Spoke-ED 111)

Forwarding Table Update for the Spoke-ED 109

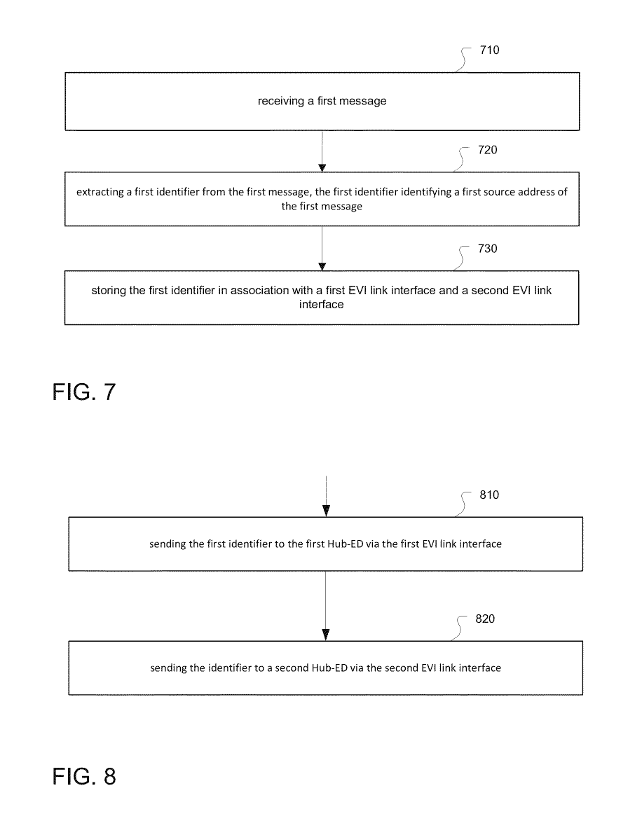

A forwarding table update process for the Spoke-ED 109 is described below with reference to FIGS. 1, 6E, 7 and 8.

The Spoke-ED 109 receives 710 an Ethernet message sent from the Spoke-CE 1031 via the Port A. The Spoke-ED 109 extracts 720 a VLAN ID, a source MAC address and a destination MAC address from the Ethernet message. In this example, the VLAN ID of the Ethernet message is VLAN 10, the source MAC address is MAC 1 (the MAC address of the host 1032 connected to the Spoke-CE 1031), the destination MAC address is MAC 2 (the MAC address of the host 1052 connected to the Spoke-CE 1051).

As there is no entry in the forwarding table 400 for the Spoke-ED 109 including MAC1 and the VLAN 10, as shown in FIG. 6A. The forwarding table 400 shown in FIG. 6A is updated to the forwarding table 400 shown in FIG. 6E as follows.

In particular, the Spoke-ED109 generates an entry having the index value of “Hub side” for the forwarding table 400 in which MAC 1, VLAN 10 and the Port A are associated, as shown in the second entry in FIG. 6E, and stores the entry in the forwarding table 400. The Spoke-ED109 further generates an entry having the index value of “Spoke side” for the forwarding table 400 in which MAC 1, VLAN 10 and the EVI link interfaces 1, 3 are associated, as shown in the fourth entry in FIG. 6E, and stores 730 the entry in the forwarding table 400.

On the other hand, as there is no entry in the forwarding table shown in FIG. 6A including VLAN 10 and the destination MAC address MAC2, the Spoke-ED 109 broadcasts the Ethernet message to the VLAN identified by VLAN 10 rather than encapsulating and sending the message to the overlay network 107, reducing broadcast traffic in the EVI network 100 resulting from a unicast message with an unknown destination MAC address. In other words, a unicast Ethernet message with an unknown destination MAC address is broadcasted in the VLAN 10 in which the message originates instead of in the entire EVI network 100.

To synchronise the source MAC address MAC 1 to other EDs in the overlay network 107, the Spoke-ED 109 generates an Intermediate System-to-Intermediate System Protocol (IS-IS) Protocol message containing VLAN 10 and MAC 1. The Spoke-ED 109 also constructs a first EVI message header and a second EVI message header for the IS-IS message according to the EVI link interfaces 1, 3, respectively. Each of the first EVI message header and the second EVI message header includes an outer layer Ethernet header and an IP Generic Routing Encapsulation (GRE) header. While Ethernet and IP GRE are mentioned here, more generally other protocols may be used for instance other layer 2 headers and another tunneling protocol to transmit the layer 2 packet through a layer 3 network.

The EVI link interfaces 1, 3 includes the following information: outer layer Ethernet header information (such as a public network VLAN ID, a MAC address of the next hop node along a EVI tunnel towards the peer ED), outer layer IP header information of an IP GRE tunnel header (such as an IP address of a local EVI tunnel interface, an IP address of the EVI tunnel interface of the peer ED), GRE tunnel header information of the IP GRE tunnel header (the type of the tunnel), an EVI message outlet (a physical port via which the EVI message is sent).

The Spoke-Ed 109 encapsulate the IS-IS message with the first EVI message header to construct a first EVI synchronisation message, and with a second EVI message header to construct a second EVI synchronisation message.

The Spoke-ED 109 sends 810 the first EVI synchronisation message to the Hub-ED 113 over the EVI link 1 via the EVI link interface 1, and sends 820 the second EVI synchronisation message to the Hub-ED 115 over the EVI link 3 via the EVI link interfaces 3. As a result, the VLAN ID of VLAN 10 and the MAC address of MAC 1 are synchronised to the Hub-EDs 113, 115.

Forwarding Table Update for the Hub-ED 113

An update process for the forwarding table 500 for the Hub-ED 113 is described with reference to FIGS. 1 and 6F.

The Hub-ED 113 receives the first EVI synchronisation message sent by the Spoke-ED 109 over the EVI link 1 via the EVI link interface 1′. The Hub-ED 113 decapsulates the first EVI synchronisation message to obtain the IS-IS message. Then the Hub-ED 113 determines that the EVI link over which the first EVI synchronisation message is received is the EVI link 1 and the EVI link interface corresponding to the EVI link 1 is the EVI Link interface 1′, according to the first EVI message header and VLAN 10 associated with MAC 1 in the IS-IS message.

The Hub-ED 113 generates two entries for the forwarding table 500 shown in FIG. 6C. In the entry having the index value of “Hub side”, MAC 1 and VLAN 10 are associated with the EVI link interface 1′; while in the entry having the index value of “Spoke side”, MAC 1 and VLAN 10 are associated with the Port C. The entries are stored in the forwarding table 500 for the Hub-ED 113. As a result, the forwarding table 500 shown in FIG. 6C is updated to the forwarding table 500 shown in FIG. 6F.

The Hub-ED 113 encapsulates the IS-IS message carrying VLAN 10 and MAC 1 with an EVI message header according to the EVI link interface 4′ to construct an EVI message for the IS-IS message. Hub-ED 113 sends the EVI message to the Spoke-ED 111 over the EVI link 4 via the EVI link interface 4′. This way the Hub-ED 113 synchronises the VLAN ID of VLAN 10 and the MAC address of MAC 1 to the Spoke-ED 111.

Forwarding Table Update for the Hub-ED 115

An update process for the forwarding table 500 for the Hub-ED 115 is described with reference to FIGS. 1 and 6G.

The Hub-ED 115 receives the second EVI synchronisation message from the Spoke-ED 109 over the EVI link 3 via the EVI link interface 3′. After decapsulation processing, the Hub-ED 115 obtains the IS-IS message containing VLAN 10 and MAC 1 and determines the EVI link interface 3′ via which the second EVI synchronisation message is received. The Hub-ED 115 generates two entries for the forwarding table 500 for the Hub-ED 115 shown in FIG. 6D. In the entry having the index value of “Hub side”, MAC 1 and VLAN 10 are associated with the EVI link interface 3′; while in the entry having the index value of “Spoke side”, MAC 1 and VLAN 10 are associated with the Port D. The entries are stored in the forwarding table 500 for the Hub-ED 115. As a result, the forwarding table 500 for the Hub-ED 115 shown in FIG. 6D is updated to the forwarding table 500 shown in FIG. 6G.

The Hub-ED 115 encapsulates the IS-IS message carrying VLAN 10 and MAC 1 with an EVI message header according to the EVI link interface 2′ to construct an EVI message for the IS-IS message. Hub-ED 115 sends the EVI message to the Spoke-ED 111 over the EVI link 2 via the EVI link interface 2′. This way the Hub-ED 115 synchronises the VLAN ID of VLAN 10 and the MAC address of MAC 1 to the Spoke-ED 111.

Forwarding Table Update for the Spoke-ED 111

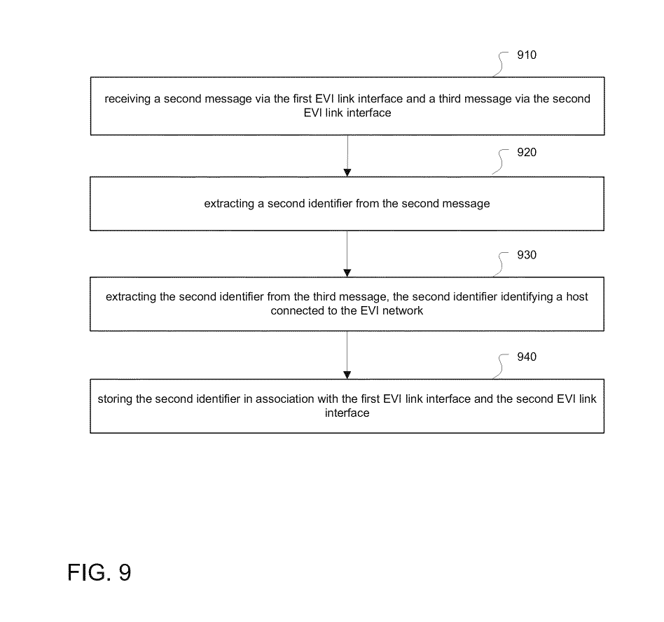

An update process for the forwarding table 400 for the Spoke-ED 111 is described with reference to FIGS. 1, 6H, 9.

The Spoke-ED 111 receives 910 the EVI message sent from Hub-ED 113 over the EVI link 4. The Spoke-ED 111 decapsulates the EVI message to obtain the IS-IS message contained in the EVI message. The Spoke-ED 111 determines that the EVI link over which the EVI message is received is EVI link 4 and the EVI link interface corresponding to the EVI link 4 is the EVI link interface 4, according to the EVI message header and VLAN 10 associated with MAC 1 in the IS-IS message. The Spoke-ED 111 extracts 920 the VLAN ID of VLAN 10 and the MAC address of MAC 1 from the IS-IS message, which represents the host 1032 in the site network 103.

The Spoke-ED 111 receives 910 the EVI message sent from the Hub-ED 115 over the EVI link 2. The Spoke-ED 111 decapsulates the EVI message to obtain the IS-IS message, and determines that the EVI link over which the EVI message is received is EVI link 2 and the EVI link interface corresponding to the EVI link 2 is the EVI link interface 2′, according to the EVI message header and VLAN 10 associated with MAC 1 in the IS-IS message. The Spoke-ED 111 extracts 930 the VLAN ID of VLAN 10 and the MAC address of MAC 1 contained in the IS-IS message, which represents the host 1032 in the site network 103.

The Spoke-ED 111 generates an entry having the index value of “Spoke side” for the forwarding table 400 shown in FIG. 6B, in which MAC 1, VLAN 10 are associated with the EVI link interfaces 2, 4. The Spoke-ED 111 stores 940 the entry in the forwarding table 400 for the Spoke-ED 111. As a result, the forwarding table 400 shown in FIG. 6B is updated to the forwarding table 400 shown in FIG. 6H.

Forwarding Table Update for Unicast Messages at the Edge Devices (from the Spoke-ED 111 to the Spoke-ED 109)

Forwarding Table Update for the Spoke-ED 111

A forwarding table update process for the Spoke-111 is described below with reference to FIGS. 1, 6I, 7 and 8.

The Spoke-ED 111 receives 710 an Ethernet message sent from the Spoke-CE 1051 via the Port B. The Spoke-ED 111 extracts 720 a VLAN ID, a source MAC address and a destination MAC address from the Ethernet message. In this example, the VLAN ID of the Ethernet message is VLAN 10, the source MAC address is MAC 2 (the MAC address of the host 1052 connected to the Spoke-CE 1051), the destination MAC address is MAC 1 (the MAC address of the host 1032 connected to the Spoke-CE 1031).

As there is no entry in the forwarding table 400 for the Spoke-ED 111 including MAC 2 and the VLAN 10, as shown in FIG. 6H. The Spoke-ED111 generates an entry having the index value of “Hub side” for the forwarding table 400 in which MAC 2, VLAN 10 and the Port B are associated, and stores the entry in the forwarding table 400. The Spoke-ED111 further generates an entry having the index value of “Spoke side” for the forwarding table 400 in which MAC 2, VLAN 10 and the EVI link interfaces 2, 4 are associated, and stores 730 the entry in the forwarding table 400. As a result, the forwarding table 400 for the Spoke-ED 111 shown in FIG. 6H is updated to the forwarding table 400 shown in FIG. 6I.

To synchronise the source MAC address MAC 2 to other EDs in the overlay network 107, the Spoke-ED 111 generates an Intermediate System-to-Intermediate System Protocol (IS-IS) Protocol message containing VLAN 10 and MAC 2. The Spoke-ED 111 also constructs a first EVI message header and a second EVI message header for the IS-IS message according to the EVI link interfaces 2, 4, respectively. The Spoke-Ed 111 encapsulates the IS-IS message with the first EVI message header to construct a first EVI synchronisation message, and with the second EVI message header to construct a second EVI synchronisation message.

The Spoke-ED 111 sends 810 the first EVI synchronisation message to the Hub-ED 113 over the EVI link 4 via the EVI link interface 4 and sends 820 the second EVI synchronisation message to the Hub-ED 115 over the EVI link 2 via the EVI link interfaces 2. As a result, the VLAN ID of VLAN 10 and the MAC address of MAC 2 are synchronised to the Hub-EDs 113, 115.

Forwarding Table Update for the Hub-ED 113

An update process for the forwarding table 500 for the Hub-ED 113 is described with reference to FIGS. 1 and 6J.

The Hub-ED 113 receives the first EVI synchronisation message sent by the Spoke-ED 111 over the EVI link 4 via the EVI link interface 4′. The Hub-ED 113 decapsulates the first EVI synchronisation message to obtain the IS-IS message. Then the Hub-ED 113 determines that the EVI link over which the first EVI synchronisation message is received is the EVI link 4 and the EVI link interface corresponding to the EVI link 4 is the EVI Link interface 4′, according to the first EVI message header and VLAN 10 associated with MAC 2 in the IS-IS message.

The Hub-ED 113 generates two entries for the forwarding table 500 for the Hub-ED 113 shown in 6F. In the entry having the index value of “Hub side”, MAC 2 and VLAN 10 are associated with the EVI link interface 4′; while in the entry having the index value of “Spoke side”, MAC 2 and VLAN 10 are associated with the Port C. The entries are stored in the forwarding table 500 for the Hub-ED 113. As a result, the forwarding table 500 for the hub-ED 113 shown in FIG. 6F is updated to the forwarding table 500 shown in FIG. 6J.

The Hub-ED 113 encapsulates the IS-IS message carrying VLAN 10 and MAC 2 with an EVI message header according to the EVI link interface 1′ to construct an EVI message for the IS-IS message. Hub-ED 113 sends the EVI message to the Spoke-ED 109 over the EVI link 1 via the EVI link interface 1′. This way the Hub-ED 113 synchronises the VLAN ID of VLAN 10 and the MAC address of MAC 2 to the Spoke-ED 109.

Forwarding Table Update for the Hub-ED 115

An update process for the forwarding table 500 for the Hub-ED 115 is described with reference to FIGS. 1 and 6K.

The Hub-ED 115 receives the second EVI synchronisation message from the Spoke-ED 111 over the EVI link 2 via the EVI link interface 2′. After decapsulation processing, the Hub-ED 115 obtains the IS-IS message containing VLAN 10 and MAC 2 and determines the EVI link interface 2′ via which the second EVI synchronisation message is received.

The Hub-ED 115 generates two entries for the forwarding table 500 for the Hub-ED 115 shown in FIG. 6G. In the entry having the index value of “Hub side”, MAC 2 and VLAN 10 are associated with the EVI link interface 2′; while in the entry having the index value of “Spoke side”, MAC 2 and VLAN 10 are associated with the Port D. The entries are stored in the forwarding table 500 for the Hub-ED 115. As a result, the forwarding table 500 for the hub-ED 115 shown in FIG. 6G is updated to the forwarding table 500 shown in FIG. 6K.

The Hub-ED 115 encapsulates the IS-IS message carrying VLAN 10 and MAC 2 with an EVI message header according to the EVI link interface 3′ to construct an EVI message for the IS-IS message. Hub-ED 115 sends the EVI message to the Spoke-ED 109 over the EVI link 3 via the EVI link interface 3′. This way the Hub-ED 115 synchronises the VLAN ID of VLAN 10 and the MAC address of MAC 2 to the Spoke-ED 109.

Forwarding Table Update for the Spoke-ED 109

An update process for the forwarding table 400 for the Spoke-ED 109 is described with reference to FIGS. 1, 6L, 9.

The Spoke-ED 109 receives 910 the EVI message sent from Hub-ED 113 over the EVI link 1. the Spoke-ED 109 decapsulates the EVI message to obtain the IS-IS message. The Spoke-ED 109 determines that the EVI link over which the EVI message is received is EVI link 1 and the EVI link interface corresponding to the EVI link 1 is the EVI link interface 1, according to the EVI message header and VLAN 10 associated with MAC 2 in the IS-IS message. The Spoke-ED 109 extracts 920 the VLAN ID of VLAN 10 and the MAC address of MAC 2 from the IS-IS message, which represents the host 1052 in the site network 105.

The Spoke-ED 109 receives 910 of the EVI message sent from the Hub-ED 115 over the EVI link 3. the Spoke-ED 109 decapsulates the EVI message to obtain the IS-IS message, and determines that the EVI link over which the EVI message is received is EVI link 3 and the EVI link interface corresponding to the EVI link 3 is the EVI link interface 3, according to the EVI message header and VLAN 10 associated with MAC 2 in the IS-IS message. The Spoke-ED 109 extracts 930 the VLAN ID of VLAN 10 and the MAC address of MAC 2 contained in the IS-IS message, which represents the host 1052 in the site network 105.

The Spoke-ED 109 generates an entry having the index value of “Spoke side” for the forwarding table 400 shown in FIG. 6E, in which MAC 2, VLAN 10 are associated with the EVI link interfaces 1, 3. The Spoke-ED 109 stores 940 the entry in the forwarding table 400 for the Spoke-ED 109. As a result, the forwarding table 400 for the Spoke-ED 109 shown in FIG. 6E is updated to the forwarding table 400 shown in FIG. 6L.

Failure Processing

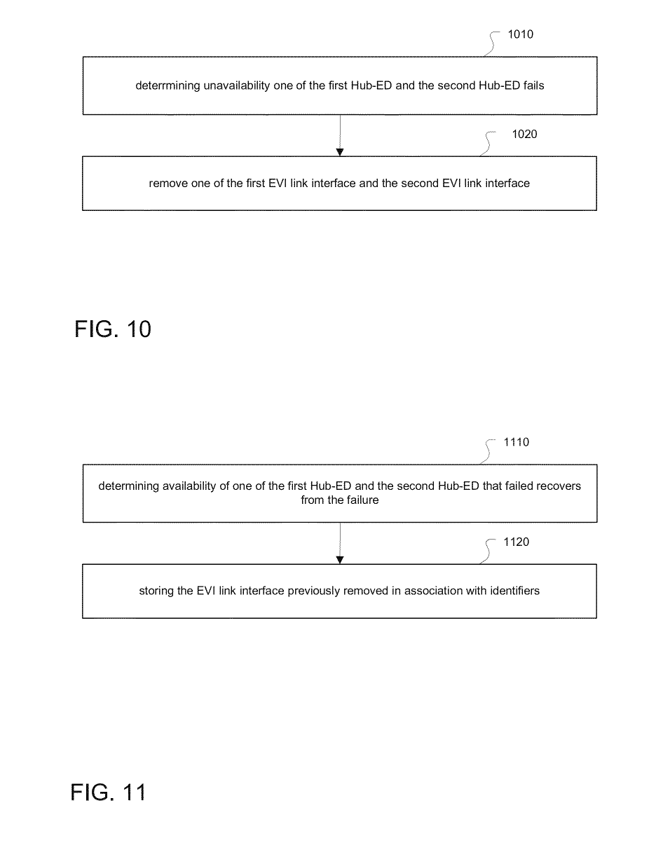

A process for failure processing is described with reference to FIGS. 6M, 6N, 10. For simplicity of description, unavailability of the Hub-ED 113 is caused by its own failure, which in turn results in down status of the EVI links 1, 4.

In this example, the Hub-ED 113 does not work normally due to a failure. As a result, the Spoke-ED 109 determines 1010 unavailability of the Hub-ED 113 by detecting the EVI link 1 connecting the Spoke-ED 109 to the Hub-ED 113 is down. Then the Spoke-ED 109 removes 1020 the EVI link interface 1 corresponding to the EVI link 1 from the forwarding table 400 for the Spoke-ED 109 shown in FIG. 6L. As a result, the forwarding table 400 for the Spoke-ED 109 shown in FIG. 6L is updated to the forwarding table 400 shown in FIG. 6M.

On the other hand, as the Hub-ED 113 does not work normally, the Spoke-ED 111 also determines 1010 unavailability of the Hub-ED 113 by detecting the EVI link 4 connecting the Spoke-ED 111 to the Hub-ED 113 is down. The Spoke-ED 111 removes 1020 the EVI link interface 4 corresponding to the EVI link 4 from the forwarding table 400 for the Spoke-ED 111 shown in FIG. 6I. As a result, the forwarding table 400 for the Spoke-ED 111 shown in FIG. 6I is updated to the forwarding table 400 shown in FIG. 6N.

Forwarding Table Update During Failure

Processes for forwarding table update during failure are described with reference to FIGS. 6O, 6P, 6Q.

Forwarding Table Update for the Spoke-ED 109

During the period that the Hub-ED 113 fails, the Spoke-ED 109 receives an Ethernet message from the Spoke-CE 1031. The Ethernet message has a source MAC address of MAC 3, which represents the host 1033 in the site network 103, a destination MAC address of MAC 2 and a VLAN ID of VLAN 10.

There is no entry in the forwarding table 400 for the Spoke-ED 109 shown in FIG. 6M that associates the source MAC address of MAC 3, the VLAN ID of VLAN 10 with an outlet.

The Spoke-ED 109 generates an entry having the index value of “Hub side” in which MAC 3, VLAN 10 and the Port A are associated. The Spoke-ED 109 further generates an entry having the index value of “Spoke side” for the forwarding table 400 in which MAC 3, VLAN 10 and the EVI link interface 3 are associated. The Spoke-ED 109 stores the entries in the forwarding table 400 for the Spoke-ED 109. As a result, the forwarding table 400 for the Spoke-ED 109 shown in FIG. 6M is updated to the forwarding table 400 shown in FIG. 6O.

The Spoke-ED 109 generates an IS-IS message carrying MAC 3 and VLAN 10 and encapsulates the IS-IS message to construct an EVI synchronisation message according to the EVI link interface 3 interfacing with the Hub-ED 115 that works normally. The Spoke-ED 109 sends the EVI synchronisation message to the Hub-ED 115 over the EVI link 3 via the EVI link interface 3.

Forwarding Table Update for the Hub-ED 115

Upon receipt of the EVI synchronisation message via the EVI link interface 3′ at the Hub-ED 115, the Hub-ED 115 decapsulates the EVI synchronisation message to obtain the IS-IS message carrying MAC 3 and VLAN 10. The Hub-ED 115 generates two entries for the forwarding table 500 for the Hub-ED 115 shown in FIG. 6K. In the entry having the index value of “Hub side”, MAC 3, VLAN 10 are associated with the EVI link interface 3′; while in the entry having the index value of “Spoke side”, MAC 3, VLAN 10 are associated with the Port D. The Hub-ED 115 further stores the entries in the forwarding table 500. As result, the forwarding table 500 for the Hub-ED 115 shown in FIG. 6K is updated to the forwarding table 500 shown in FIG. 6P.

The Hub-ED 115 encapsulates the IS-IS message carrying MAC 3 and VLAN 10 to construct an EVI message, and send the EVI message to the Spoke-ED 111 over the EVI link 2 via the EVI link interface 2′. This way MAC 3 and VLAN 10 are synchronised to the Spoke-ED 111.

Forwarding Table Update for the Spoke-ED 111

Upon receipt of the EVI message at the Spoke-ED 111, the Spoke-ED 111 decapsulates the EVI message to obtain the IS-IS message carrying MAC 3 and VLAN 100.

The Spoke-ED 111 generates an entry having the index value of “Spoke side” for the forwarding table 400 for the Spoke-ED 111, which associates MAC 3, VLAN with the EVI link interface 2, and stores the entry in the forwarding table 400. As a result, the forwarding table 400 for the Spoke-ED 111 shown in FIG. 6N is updated to the forwarding table 400 shown in FIG. 6Q.

Failure Recovery

Processes for forwarding table update after failure recovery are described with reference to FIGS. 6R, 6S, 6T, 11.

Forwarding Table Update for the Spoke-ED 109

When the Hub-ED 113 recovers from the failure, the Spoke-ED 109 determines 1110 availability of the Hub-ED 113 by detecting the EVI link 1 connecting the Spoke-ED 109 to the Hub-ED 113 is up.

The Spoke-ED 109 stores 1120, in entries have the index value of “Spoke side” in the forwarding table 400 for the Spoke-ED 109 shown in FIG. 6O, the EVI link interface 1 corresponding to the EVI link 1 in association with the broadcast MAC address, VLAN 10 and the EVI link interface 3 (the fourth entry in FIG. 6R), in association with MAC 1, VLAN 10 and the EVI link interface 3 (the fifth entry in FIG. 6R), in association with MAC 2, VLAN 10 and the EVI link interface 3 (the sixth entry in FIG. 6R), and in association with MAC 3, VLAN 10 and the EVI link interface 3 (the seventh entry in FIG. 6R), respectively. As a result, the forwarding table 400 for the Spoke-ED 109 shown in FIG. 6O is updated to the forwarding table 400 shown in FIG. 6R.

The Spoke-ED 109 searches the entries having the index value of “Hub side” in the forwarding table 400 shown in FIG. 6R to determine unicast MAC addresses and VLAN IDs for local hosts, which are the hosts 1032, 1033 in this example. As a result, the second and third entries in FIG. 6R are found.

The Spoke-ED 109 generates a first IS-IS message carrying MAC 1 and VLAN 10 according to the second entry, and generates a second IS-IS message carrying MAC 3 and VLAN 10 according to the third entry.

The Spoke-ED 109 encapsulates the first and second IS-IS messages according to the EVI link interface 1, which corresponds to the EVI link 1 connecting the Spoke-ED 109 to the Hub-ED 113 that has recovered, to construct a first EVI synchronisation message and a second EVI synchronisation message.

The Spoke-ED 109 sends the first EVI synchronisation message and the second EVI synchronisation message over the EVI link 1 via the EVI link interface 1 to the Hub-ED 113. This way the MAC addresses MAC 1 and MAC 3, which is the MAC address that the Spoke-ED has learnt during the Hub-ED 113 fails, are synchronised to the Hub-ED 113. In this example, the MAC addresses are synchronised to the Hub-ED 113 through separated EVI synchronisation messages. In another example, the MAC addresses may be synchronised to the Hub-ED 113 through a same EVI synchronisation message to save bandwidth of the EVI tunnel carrying the EVI synchronisation message.

Forwarding Table Update for the Spoke-ED 111

When the Hub-ED 113 recovers from the failure, the Spoke-ED 111 determines 1110 availability of the Hub-ED 113 by detecting the EVI link 4 connecting the Spoke-ED 111 to the Hub-ED 113 is up.

The Spoke-ED 111 stores 1120, entries having the index value of “Spoke side” in the forwarding table 400 for the Spoke-ED 111 shown in FIG. 6Q, the EVI link interface 4 corresponding to the EVI link 4 in association with the broadcast MAC address, VLAN 10 and the EVI link interface 2 (the third entry in FIG. 6S), in association with MAC 1, VLAN 10 and the EVI link interface 2 (the fourth entry in FIG. 6S), in association with MAC 2, VLAN 10 and the EVI link interface 2 (the fifth entry in FIG. 6S), and in association with MAC 3, VLAN 10 and the EVI link interface 2 (the sixth entry in FIG. 6S), respectively. As a result, the forwarding table 400 for the Spoke-ED 111 shown in FIG. 6Q is updated to the forwarding table 400 shown in FIG. 6S.

The Spoke-ED 111 searches the entries having the index value of “Hub side” in the forwarding table 400 shown in FIG. 6S to determine unicast MAC addresses and VLAN IDs for local hosts, which is the host 1052 in this example. As a result, the second entry in FIG. 6S is found.

The Spoke-ED 111 generates a third IS-IS message carrying MAC 2 and VLAN 10 according to the second entry.

The Spoke-ED 111 encapsulates the third IS-IS messages according to the EVI link interface 4, which corresponds to the EVI link 4 connecting the Spoke-ED 111 to the Hub-ED 113 that has recovered, to construct a third EVI synchronisation message.

The Spoke-ED 111 sends the third EVI synchronisation message over the EVI link 4 via the EVI link interface 4′ to the Hub-ED 113. This way the MAC address MAC 2 is synchronised to the Hub-ED 113.

Forwarding Table Update for the Hub-ED 113

Upon receipt of the first, second and third EVI synchronisation message at the Hub-ED 113, the Hub-ED 113 decapsulates the EVI synchronisation messages to obtain the first, second and third IS-IS messages, respectively, which carry the MAC addresses MAC 1, MAC 2 and MAC 3, respectively.

The Hub-ED 113 generate entries to associate the MAC addresses, VLAN 10, the Port C, and EVI link interfaces 1′, 4′, and stores these entries in the forwarding table 500 for the Hub-ED 113. As a result, a new forwarding table 500 for the Hub-ED 113 is produced, shown as the forwarding table 500 in FIG. 6T.

Subsequently, the Spoke-EDs 109, 111 and the Hub-ED 113 perform message forwarding functions according to the respective forwarding tables shown in FIGS. 6R, 6S and 6T.

Further, the processes, methods and functional units or modules described in this disclosure may be implemented by hardware or by software. For example a plurality of machine readable instructions stored on a non-transitory storage medium and executable by a processor to implement the methods and functional units or modules recited in the examples of the present disclosure. There may be a single processor and non-transitory storage medium or plural processors and/or storage mediums in which the methods and functional units may be distributed between them. The functional units or modules described in the examples of the present disclosure may also be implemented by one or more dedicated hardware units, for example, application-specific integrated circuits (ASIC).

The figures are only illustrations of an example, wherein the units or procedure shown in the figures are not necessarily essential for implementing the present disclosure. The units or modules in the devices in the examples can be arranged as described, or can be located in one or more devices differently than shown in the examples. For example, the units or modules in the examples described can be combined into one module or further divided into a plurality of sub-units or sub-modules.

Although the flow charts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

1. A device for use in an Ethernet Virtualisation Interconnection (EVI) network having a Hub-Spoke structure, the EVI network comprises a first Hub Edge Device (Hub-ED) and a second Hub-ED, the device comprising:
a memory unit to store instructions; and
a processor to perform the instructions from the memory unit
to receive a message having an identifier, the identifier identifying a destination address of the message,
to select an EVI link interface from a set of EVI link interfaces having a first EVI link interface and a second EVI link interface each associated with the identifier, wherein the first EVI link interface interfaces with the first Hub-ED and the second EVI link interface interfaces with the second Hub-ED, and
to send the message to one of the first Hub-ED or the second Hub-ED via the EVI link interface selected from the set of EVI link interfaces.

2. The device according to claim 1, wherein the processor further performs the instructions from the memory unit to select the EVI link interface based on a load-sharing rule.

3. A device for use in an Ethernet Virtualisation Interconnection (EVI) network having a Hub-Spoke structure, the EVI network comprises a first Hub Edge Device (Hub-ED) and second Hub-ED, the device comprising:
a memory unit to store instructions;
a storage;
a processor to perform the instructions from the memory unit
to receive a first message,
to extract a first identifier from the first message, the first identifier identifying a first source address of the first message, and
to store, in the storage, the first identifier in association with a first EVI link interface and a second EVI link interface.

4. The device according to claim 3, wherein the processor further performs the instructions from the memory unit
to send the first identifier to the first Hub-ED via the first EVI link interface, and
to send the first identifier to the second Hub-ED via the second EVI link interface.

5. The device according to claim 3, wherein the processor further performs the instructions from the memory unit
to receive a second message via the first EVI link interface and a third message via the second EVI link interface,
to extract a second identifier from the second message,
to extract the second identifier from the third message, the second identifier identifying a remote host, and
to store, in the storage, the second identifier in association with the first EVI link interface and the second EVI link interface.

6. The device according to claim 3, wherein the processor further performs the instructions from the memory unit to store, in the storage, a third identifier for broadcast in association with the first EVI link interface and the second EVI link interface.

7. The device according to claim 3, the processor further performs the instructions from the memory unit to remove, from the storage, one of the first EVI link interface and the second EVI link interface.

8. The device according to claim 7, the processor further performs the instructions from the memory unit to store, in the storage, the one of the first EVI link interface or the second EVI link interface previously removed from the storage in association with the first identifier and the second identifier.

9. A method for use in an Ethernet Virtualisation Interconnection (EVI) network having a Hub-Spoke structure, the EVI network comprises a first Hub Edge Device (Hub-ED) and second Hub-ED, the method comprising:
receiving a first message having a first identifier, the first identifier identifying a destination address of the first message;
selecting an EVI link interface from a set of EVI link interfaces having a first EVI link interface and a second EVI link interface each associated with the first identifier, wherein the first EVI link interface interfaces with the first Hub-ED and the second EVI link interface interfaces with the second Hub-ED; and
sending the message to one of the first Hub-ED or the second Hub-ED via the EVI link interface selected from the set of EVI link interfaces.

10. The method according to claim 9, the method comprising:
receiving a second message;
extracting a second identifier from the second message, the second identifier identifying a first source address of the second message; and
storing, in a storage, the second identifier in association with the first EVI link interface and the second EVI link interface.

11. The method according to claim 10, the method further comprising:
sending the second identifier to the first Hub-ED via the first EVI link interface; and
sending the second identifier to the second Hub-ED via the second EVI link interface.

12. The method according to claim 11, wherein the method further comprising:
receiving a third message via the first EVI link interface and a fourth message via the second EVI link interface;
extracting a third identifier from the third message,
extracting the third identifier from the fourth message, the third identifier identifying a remote host, and
storing, in the storage, the third identifier in association with the first EVI link interface and the second EVI link interface.

13. The method according to claim 10, the method further comprising:
storing, in the storage, a fourth identifier for broadcast in association with the first EVI link interface and the second EVI link interface.

14. The method according to claim 10, the method further comprising:
removing, from the storage, one of the first EVI link interface and the second EVI link interface.

15. The method according to claim 14, the method further comprising:
storing, in the storage, the one of the first EVI link interface and the second EVI link interface previously removed from the storage in association with the second identifier and the third identifier.
